(19) United States
(12) Patent Application Publication
(10) Pub. No.: US 2018/0135805 A1
(43) Pub. Date: May 17, 2018

(54) OPEN LOOP VAPORIZATION SYSTEM AND A METHOD THEREOF

(71) Applicant: PRISERVE CONSULTING INC, Houston, TX (US)

(72) Inventors: Daniel Doogyoon Kim, Houston, TX (US); Saumen Prasad, Houston, TX (US); Ramakrishnan Hari Prasad, Katy, TX (US)

(21) Appl. No.: 15/811,863

(22) Filed: Nov. 14, 2017

Related U.S. Application Data
(60) Provisional application No. 62/421,889, filed on Nov. 14, 2016.

(51) Int. Cl. F17C 9/02; F17C 13/02; F17C 13/04; F17C 13/08

(52) U.S. Cl. CPC F17C 9/02; F17C 13/026; F17C 13/04; F17C 13/082; F17C 2221/033; F17C 2250/072; F17C 2225/0123; F17C 2227/0318; F17C 2250/03; F17C 2250/0439; F17C 2250/0631; F17C 2223/013

(57) ABSTRACT

An open loop vaporization system (200), comprises a regasification module (130) having an influent side (1301) and an effluent side (1302), a plurality of auxiliary pumps (210) configured to draw sea water from a plurality of sea chests (122), a first three-way valve (230), the first three-way valve (230) having a first three-way valve inlet (2301) and a primary first three-way valve outlet (2302), a control module (140) with a controller network (145), a first temperature sensor (240) connected with piping (150). Further, the first temperature sensor (240) is configured to measure a first temperature value and transmit the first temperature value to the control module (140). Also, the control module (140) is configured to open the primary first three-way valve outlet (2302) and discharge the effluent sea water overboard through an overboard line, if the first temperature value is higher than a reference temperature value.

### FIELD OF THE INVENTION

The Embodiments of the present invention relate to Floating Storage and Regasification Units (FSRUs) and more particularly to an open loop vaporization system and method thereof.

### BACKGROUND ART

An FSRU (Floating Storage and Regasification Unit) is primarily employed, as the name suggests, for loading on LNG (Liquefied Natural Gas) for storage in on-board cargo tanks prior to conversion/regasification and delivery of NG (Natural Gas) to pipelines and onshore facilities.

Regasification is a process of converting liquefied natural gas (LNG) at approximately −162° C. (−260° F.) temperature back to natural gas at atmospheric temperature. For this process, seawater at higher ambient temperature relative to the LNG is used as the heat source medium. The FSRU intends to utilize an open loop system, where in, seawater surrounding the unit is circulated through the regasification module after which the colder seawater is discharged back to the open sea. The overboard disposal of the colder seawater has to be in compliance with the EPA (Environmental Protection Agency) and must meet requirements of the local authorities as well.

EPA (EPA-842-R-99-001) stipulates that the difference in temperature from influent sea water to effluent sea water is usually between 10 deg. F. to 15 deg. F., but the range can be as much as 5 deg. F. to 25 deg. F.

Environment, Health, and Safety Guidelines for Offshore Oil and Gas Development, published by World Bank Group on Jun. 5, 2015, state that the temperature of the effluent sea water should be within 3 degrees Celsius of ambient seawater temperature at the edge of the defined mixing zone, or if the mixing zone is not defined, within 100 meters of the discharge.

There have been a number of solutions suggested in this regard, some of which are listed below:

JP5254716B2 discloses a system for heating the effluent sea water of the re-gasification unit. The system uses waste steam from a steam turbine, in a steam condenser to reheat the effluent sea water.

KR101647462B1 discloses a system for heating the effluent sea water of the re-gasification unit. The system employs a scrubber in which exhaust gases generated from the vessel's internal combustion engine or internal combustion engines located off-shore, are used to heat the effluent sea water.

The aforesaid documents and other solutions may aim to provide open loop vaporization systems which are within regulations, however they still need employment of additional heating loops and complicated equipment such as the condenser and the scrubber, which may need significant amount of maintenance. Further, the waste steam and the exhaust gases may not always be available in sufficient quantity.

Therefore, there remains a need in the art for an open loop vaporization system and a method which does not suffer from above mentioned discrepancies.

However, there remains a need in the art for an improved open loop vaporization system and method, which is simple, cost-effective and efficient.

Any discussion of the background art throughout the specification should in no way be considered as an admission that such background art is prior art nor that such background art is widely known or forms part of the common general knowledge in the field.

### SUMMARY OF THE INVENTION

According to a first aspect of the present invention, an open loop vaporization system is disclosed. The open loop vaporization system comprises a regasification module having an influent side and an effluent side, a plurality of auxiliary pumps configured to draw sea water from a plurality of sea chests, a first junction, the first junction having a primary first junction inlet, a secondary first junction inlet and a first junction outlet, a second junction, the second junction having a primary second junction inlet, a secondary second junction inlet and a second junction outlet, the first junction outlet being connected with the primary second junction inlet and the secondary second junction inlet being connected with the effluent side, a first three-way valve, the first three-way valve having a first three-way valve inlet, a primary first three-way valve outlet and a secondary first three-way valve outlet, a throttling valve having a valve inlet and a valve outlet, the valve inlet being connected in line with the plurality of auxiliary pumps and the valve outlet being connected with the primary first junction inlet, a control module with a controller network, a first temperature sensor connected with the piping at the effluent side. Further, the throttling valve and the plurality of auxiliary pumps are configured to be actuated by the control module through the controller network. Further, the first three-way valve and the throttling valve are temperature controlled. Further, the first junction, the second junction and the first three-way valve form a loop. Further, the regasification module is configured to convert Liquefied Natural Gas (LNG) stored on board an FSRU into natural gas using heat from influent sea water coming in from the influent side, giving out effluent sea water from the effluent side. Further, the first three-way valve inlet is configured to receive the effluent sea water leaving the regasification module, through the second junction. Further, the first temperature sensor is configured to measure a first temperature value in the piping at the effluent side of the regasification module and transmit the first temperature value to the control module. Further, the control module is configured to open the primary first three-way valve outlet and discharge the effluent sea water overboard through the overboard line, if the received first temperature value is higher than a reference temperature value.

In accordance with an embodiment of the invention, the control module is further configured to close the primary first three-way valve outlet and actuate the at least one of the plurality of auxiliary pumps, drawing in influent sea-water from the plurality of sea-chests, if the received first temperature value is lower than the reference temperature value. Further, the secondary first three-way valve outlet is configured to allow the effluent sea water to exit out of the first three-way valve and mix with the influent sea water at the first junction, creating an effluent-influent mix. Further, the first junction outlet is configured to allow the effluent-influent mix to leave the first junction and enter the second junction through the primary second junction inlet.

In accordance with an embodiment of the invention, the second junction is configured to mix the additional effluent sea water entering through the secondary second junction inlet with the effluent-influent mix.

In accordance with an embodiment of the invention, the second junction outlet is configured to allow the effluent-influent mix to leave the second junction and reach the first three-way valve inlet.

In accordance with an embodiment of the invention, the system further comprises an auxiliary temperature sensor connected with the piping at the first three-way valve inlet. Further, the auxiliary temperature sensor is configured to measure an auxiliary temperature value in the piping at the first three-way valve inlet and transmit the auxiliary temperature value to the control module. Further, the control module is further configured to open the primary first three-way valve outlet and discharge the effluent-influent mix overboard, if the auxiliary temperature value is higher than the reference temperature value.

In accordance with an embodiment of the invention, the control module is further configured to close the primary first three-way valve outlet, if the auxiliary temperature value is lower than the reference temperature value.

In accordance with an embodiment of the invention, the loop is configured to allow the effluent-influent nix to re-circulate through the secondary first three-way valve outlet, receiving additional influent sea water from the throttling valve at the first junction, until the auxiliary temperature value exceeds the reference temperature value.

According to a second aspect of the present invention, an open loop vaporization system is disclosed. The open loop vaporization system comprises a plurality of ballast tanks, a plurality of auxiliary pumps connected with a plurality of auxiliary tank outlets of the plurality of respective ballast tanks, a regasification module having an influent side and an effluent side, a first three-way valve, the first three-way valve having a first three-way valve inlet, a primary first three-way valve outlet and a secondary first three-way valve outlet, the effluent side is connected with the first three-way valve inlet of the first three-way valve, a second three-way valve, the second three-way valve having a second three-way valve inlet, a primary second three-way valve outlet and a secondary second three-way valve outlet, the second three-way valve inlet being connected with the plurality of auxiliary pumps, the primary second three-way valve outlet being connected with the overboard line of the piping and the secondary second three-way valve outlet being connected with the plurality of auxiliary tank inlets, a control module with a controller network, a first temperature sensor connected with the piping at the first three-way valve inlet, a second temperature sensor connected with the piping at the second three-way valve inlet. Further, the regasification module is configured to convert Liquefied Natural Gas (LNG) stored on board an FSRU into natural gas using heat from influent sea water coming in from the influent side, giving out effluent sea water from the effluent side. Further, the first three-way valve and second three-way valve are temperature controlled and are configured to be actuated by the control module through the controller network. Further, the first three-way valve inlet is configured to receive the effluent sea water leaving through the effluent side. Further, the first temperature sensor is configured to measure the first temperature value and transmit the first temperature value to the control module. Further, the control module is configured to open the primary first three-way valve outlet and discharge the effluent sea water overboard through the overboard line, if the first temperature value is higher than a reference temperature value.

In accordance with an embodiment of the invention, the control module is further configured to close the primary first three-way valve outlet, if the first temperature value is lower than the reference temperature value. Further, the plurality of ballast tanks is configured to receive the effluent sea through the plurality of auxiliary tank inlets, exiting the secondary first three-way valve outlet. Further, the plurality of auxiliary pumps is configured to pump the effluent-ballast sea water mixture, through the plurality of auxiliary tank outlets. Further, the second three-way valve inlet is configured to receive the effluent-ballast sea water mixture. Further, the second temperature sensor is configured to measure a second temperature value in the piping and transmit the second temperature value to the control module. Further, the control module is configured to open the primary second three-way valve outlet and discharge the effluent-ballast sea water mixture overboard, if the second temperature value is higher than the reference temperature value.

In accordance with an embodiment of the invention, the control module is further configured to close the primary second three-way valve outlet and allow the effluent-ballast sea water mixture to exit through the secondary second three-way valve outlet and enter the plurality of ballast tanks through the plurality of auxiliary tank inlets, if the second temperature value is lower than the reference temperature value.

According to a third aspect of the present invention, there is provided an open loop vaporization system, comprising, a first heat exchanger provided inside a first ballast tank of a plurality of ballast tanks, the first heat exchanger having a first heat exchanger inlet and a first heat exchanger outlet, a plurality of auxiliary pumps connected with the first heat exchanger inlet, a regasification module having an influent side (1301) and an effluent side, a first three-way valve, the first three-way valve having a first three-way valve inlet, a primary first three-way valve outlet and a secondary first three-way valve outlet, the effluent side being connected with the first three-way valve inlet of the first three-way valve, the primary first three-way valve outlet being connected with an overboard line of piping, the secondary first three-way valve outlet being connected with the plurality of auxiliary pumps, a third three-way valve, the third three-way valve having a third three-way valve inlet, a primary third three-way valve outlet and a secondary third three-way valve outlet, the third three-way valve inlet being connected with the first heat exchanger outlet and the primary third three-way valve outlet being connected with the overboard line of the piping, a first temperature sensor connected with the piping at the first three-way valve inlet, a third temperature sensor connected with the piping at the third three-way valve inlet, a control module with a controller network. Further, the regasification module is configured to convert Liquefied Natural Gas (LNG) stored on board the FSRU, into natural gas, using heat from influent sea water coining in from the influent side, giving out effluent sea water from the effluent side. Further, the first three-way valve inlet is configured to receive the effluent sea water leaving from the effluent side of the regasification module. Further, the first temperature sensor is configured to measure a first temperature value in the piping and transmit the first temperature value to the control module. Also, the control module is configured to open the primary first three-way valve outlet and discharge the effluent sea water overboard through the overboard line, if the first temperature value is higher than a reference temperature value.

In accordance with an embodiment of the invention, the control module is configured to close the primary first three-way valve outlet and open the secondary first three-way valve outlet, if the first temperature value is lower than the reference temperature value. Further, the plurality of auxiliary pumps is configured to pump the effluent sea water into the first heat exchanger through the first heat exchanger inlet. Further, the third three-way valve inlet is configured to receive the effluent sea water leaving the first heat exchanger. Further, the third temperature sensor is configured to measure a third temperature value of the effluent sea water and transmit the third temperature value to the control module. Further, the control module is configured to open the primary third three-way valve outlet and discharge the effluent sea water leaving the first heat exchanger, overboard, if the third temperature value is higher than the reference temperature value.

In accordance with an embodiment of the invention, the system further comprises a second heat exchanger provided inside a second ballast tank of the plurality of ballast tanks, the second heat exchanger having a second heat exchanger inlet connected with the secondary third three-way valve outlet and a second heat exchanger outlet. Further, the control module is configured to open the secondary third three-way valve outlet and allow the effluent sea water to enter into the second heat exchanger at the second heat exchanger inlet, if the third temperature value is lower than the reference temperature value.

In accordance with an embodiment of the invention, the further comprises a fourth three-way valve, the fourth three-way valve having a fourth three-way valve inlet, a primary fourth three-way valve outlet and a secondary fourth three-way valve outlet, the fourth three-way valve inlet being connected with the second heat exchanger outlet and the primary fourth three-way valve outlet being connected with the overboard line of the piping, a fourth temperature sensor connected with the piping at the fourth three-way valve inlet. Further, the fourth three-way valve inlet is configured to receive the effluent sea water leaving the second heat exchanger. Further, the fourth temperature sensor is configured to measure a fourth temperature value of the effluent sea water and transmit the fourth temperature value to the control module. Further, the control module is configured to open the primary fourth three-way valve outlet and discharge the effluent sea water leaving the second heat exchanger, overboard, if the fourth temperature value is higher than the reference temperature value.

According to a fourth aspect of the present invention, there is provided a method of open loop vaporization, comprising steps of converting Liquefied Natural Gas (LNG) stored on board an FSRU into natural gas using heat from influent sea water coming in from influent side, giving out effluent sea water from an effluent side, by a regasification module, measuring a first temperature value of the effluent sea water, in piping, at the effluent side of the regasification module, opening a primary first three-way valve outlet of a first three-way valve and discharging the effluent sea water overboard through an overboard line, if the first temperature value is higher than a reference temperature value, closing the primary first three-way valve outlet and actuating a throttling valve and at least one of a plurality of auxiliary pumps for drawing in influent sea-water from a plurality of sea-chests, if the received first temperature value is lower than the reference temperature value, allowing the effluent sea water to exit out of the first three-way valve and mix with the influent sea water at a first junction, creating an effluent-influent mix, measuring an auxiliary temperature value of the effluent-influent mix, in the piping at the first three-way valve inlet and opening the primary first three-way valve outlet and discharging the effluent-influent mix overboard through the overboard line, if the auxiliary temperature value is higher than the reference temperature value.

In accordance with an embodiment of the invention, the method further comprises a step of closing the primary first three-way valve outlet, if the auxiliary temperature value is lower than the reference temperature value and allowing the effluent-influent mix to re-circulate through a secondary first three-way valve outlet, receiving additional influent sea water from the throttling valve at the first junction, until the auxiliary temperature value exceeds the reference temperature value.

According to a fifth aspect of the present invention, there is provided a method of open loop vaporization, comprising steps of convening Liquefied Natural Gas (LNG) stored on board an FSRU into natural gas using heat from influent sea water coming in from influent side, giving out effluent sea water from effluent side, by a regasification module, receiving the effluent sea water leaving through the effluent side at a first three-way valve inlet of a first three-way valve and measuring a first temperature value of the effluent sea water, in piping, at the first three-way valve inlet, opening a primary first three-way valve outlet of the first three-way valve and discharging the effluent sea water overboard through an overboard line, if the first temperature value is higher than a reference temperature value, closing primary first three-way valve outlet, if the first temperature value is lower than the reference temperature value and receiving the effluent sea-water exiting a secondary first three-way valve outlet of a first three-way valve, in a plurality of ballast tanks through a plurality of auxiliary tank inlets, creating an effluent-ballast sea water mixture, pumping the effluent-ballast sea water mixture, through a plurality of auxiliary tank outlets and receiving the effluent-ballast sea water mixture in a second three-way valve inlet of a second three-way valve, measuring a second temperature value of the effluent-ballast sea water mixture, in the piping at the second three-way valve inlet and opening a primary second three-way valve outlet of the second three-way valve and discharging the effluent-ballast sea water mixture overboard, if the second temperature value is higher than the reference temperature value.

In accordance with an embodiment of the invention, the method further comprises a step of closing the primary second three-way valve outlet and allowing the effluent-ballast sea water mixture to exit through the secondary second three-way valve outlet of the second three-way valve and enter the plurality of ballast tanks through the plurality of auxiliary tank inlets, if the second temperature value is lower than the reference temperature value.

According to a sixth aspect of the present invention, there is provided a method of open loop vaporization, comprising steps of converting Liquefied Natural Gas (LNG) stored on board FSRU into natural gas using heat from influent sea water coming in from an influent side, giving out effluent sea water from the effluent side, by a regasification module, receiving the effluent sea water leaving through the effluent side at a first three-way valve inlet of a first three-way valve and measuring a first temperature value of the effluent sea water, in piping, at the first three-way valve inlet, opening a primary first three-way valve outlet of the first three-way valve and discharging the effluent sea water overboard through an overboard line, if the first temperature value is higher than a reference temperature value, pumping the effluent sea water into a first heat exchanger through a first heat exchanger inlet and receiving the effluent sea water leaving the first heat exchanger at a third three-way valve inlet of a third three-way valve, measuring a third temperature value of the effluent sea water leaving the first heat exchanger, at the third three-way valve inlet and opening a primary third three-way valve outlet of the third three-way valve and discharging the effluent sea water leaving the first heat exchanger, overboard, if the third temperature value is higher than the reference temperature value.

In accordance with an embodiment of the invention, the method further comprises steps of opening the secondary third three-way valve outlet and allowing the effluent sea water to enter into a second heat exchanger at a second heat exchanger inlet, if the third temperature value is lower than the reference temperature value, measuring a fourth temperature value of the effluent sea water leaving the second heat exchanger, at the fourth three-way valve inlet and opening a primary fourth three-way valve outlet of the fourth three-way valve and discharging the effluent sea water leaving the second heat exchanger, overboard, if the fourth temperature value is higher than the reference temperature value.

### BRIEF DESCRIPTION OF THE DRAWINGS

At least one example of the invention will be described with reference to the accompanying drawings, in which:

So that the manner in which the above recited features of the present invention can be understood in detail, a more particular description of the invention, briefly summarized above, may have been referred by examples, some of which are illustrated in the appended drawings. It is to be noted, however, that the appended drawing illustrates only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1A illustrates a plan view of an exemplary Floating Storage and Regasification unit in accordance with an embodiment of the present invention.

FIG. 1B illustrates an exemplary regasification module, in accordance with an embodiment of the present invention;

FIG. 2A illustrates an open loop vaporization system, in accordance with an embodiment of the present invention;

FIG. 2B illustrates an exemplary throttling valve, in accordance with an embodiment of the present invention;

FIG. 2C illustrates an exemplary first junction, in accordance with an embodiment of the present invention;

FIG. 2D illustrates an exemplary second junction, in accordance with an embodiment of the present invention;

FIG. 2E illustrates an exemplary first three-way valve, in accordance with an embodiment of the present invention;

FIG. 3A illustrates an open loop vaporization system, in accordance with another embodiment of the present invention;

FIG. 3B illustrates an exemplary second three-way valve, in accordance with an embodiment of the present invention;

FIG. 4A illustrates an open loop vaporization system, in accordance with yet another embodiment of the present invention;

FIG. 4B illustrates an exemplary first heat exchanger, in accordance with an embodiment of the present invention;

FIG. 4C illustrates an exemplary second heat exchanger, in accordance with an embodiment of the present invention;

FIG. 4D illustrates an exemplary third three-way valve, in accordance with an embodiment of the present invention;

FIG. 4E illustrates an exemplary fourth three-way valve, in accordance with an embodiment of the present invention;

FIG. 5 illustrates a method of open loop vaporization, in accordance with an embodiment of the present invention;

FIG. 6 illustrates a method of open loop vaporization, in accordance with another embodiment of the present invention; and

FIG. 7 illustrates a method of open loop vaporization, in accordance with yet another embodiment of the present invention.

It should be noted that the same numeral represents the same or similar elements throughout the drawings.

### DETAILED DESCRIPTION OF THE EMBODIMENTS

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

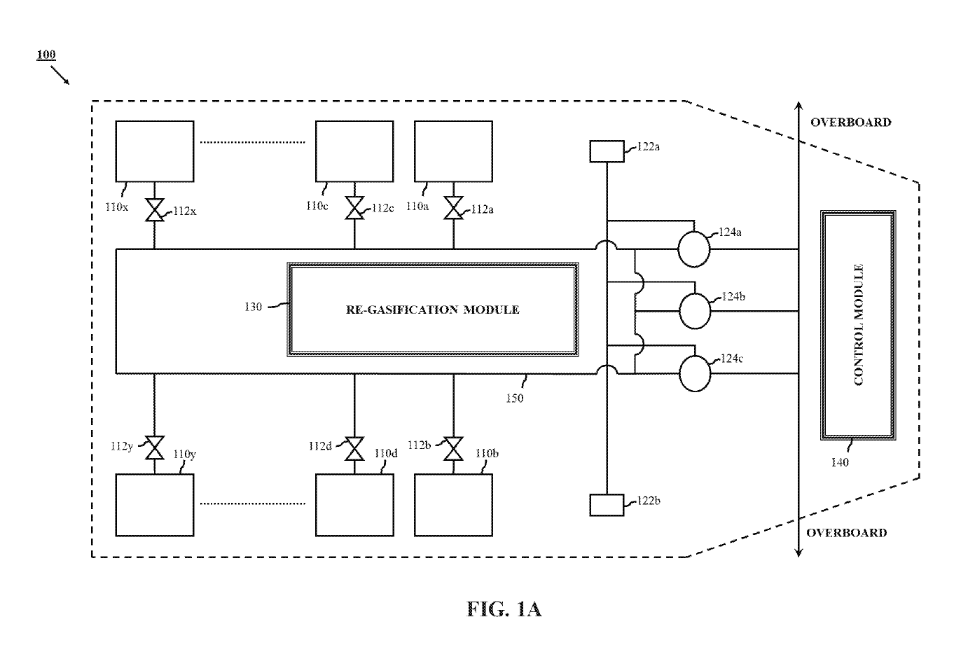

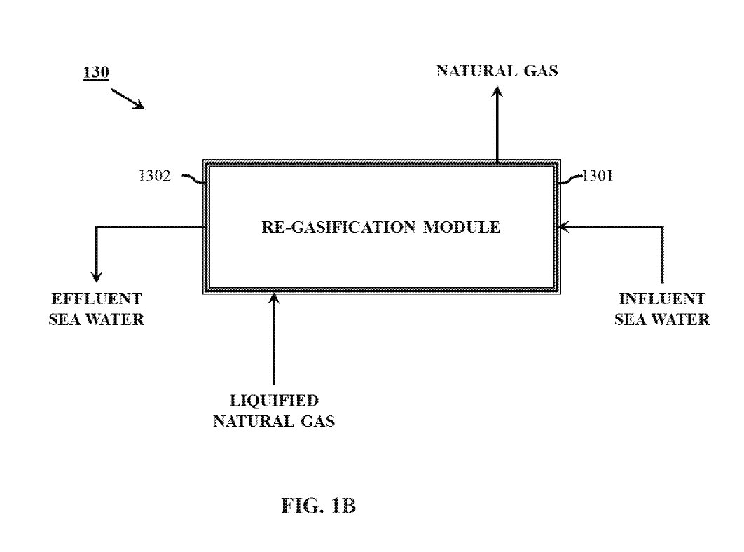

The exemplary Floating Storage and Regasification Unit (FSRU) (100) as shown in FIG. 1A comprises a plurality of ballast tanks (110) (for e.g. 110a, 110b, 110c . . . 110x, 110y etc.) having a plurality of respective ballast water inlets (1101) (for e.g. 1101a, 1101b, 1101c . . . 1101x, 1101y) and a plurality of respective ballast water outlets (1102) (for e.g. 1102a, 1102b, 1102c . . . 1101x, 1101y). The plurality of ballast tanks (110) are configured to hold sea water in order to provide stability to the FSRU (100). The sea water can be pumped in and out of the plurality of ballast tanks (110) through piping (150) using a plurality of ballast pumps (124) (for e.g. 124a, 124b and 124c). The plurality of ballast pumps (124) draws water from the sea through a plurality of sea chests (122) (for e.g. 122a and 122b). The inflow and outflow of the sea water into and from the plurality of ballast tanks (110), respectively, is regulated through a plurality of respective valves (112) (for e.g. 112a, 112b, 112c . . . 112x, 112y etc.).

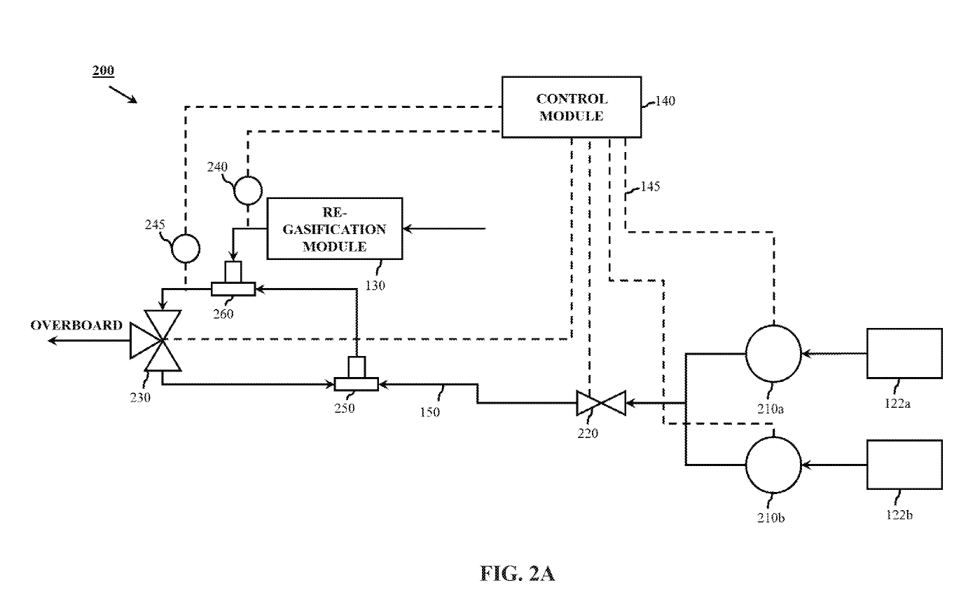

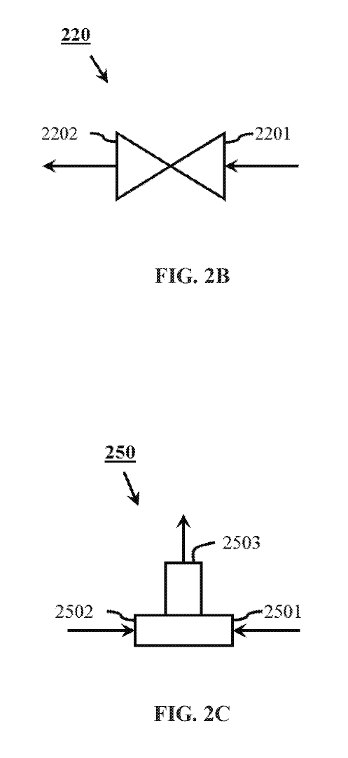

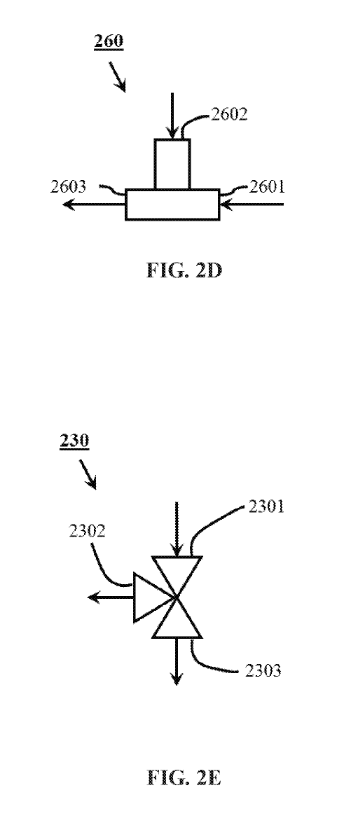

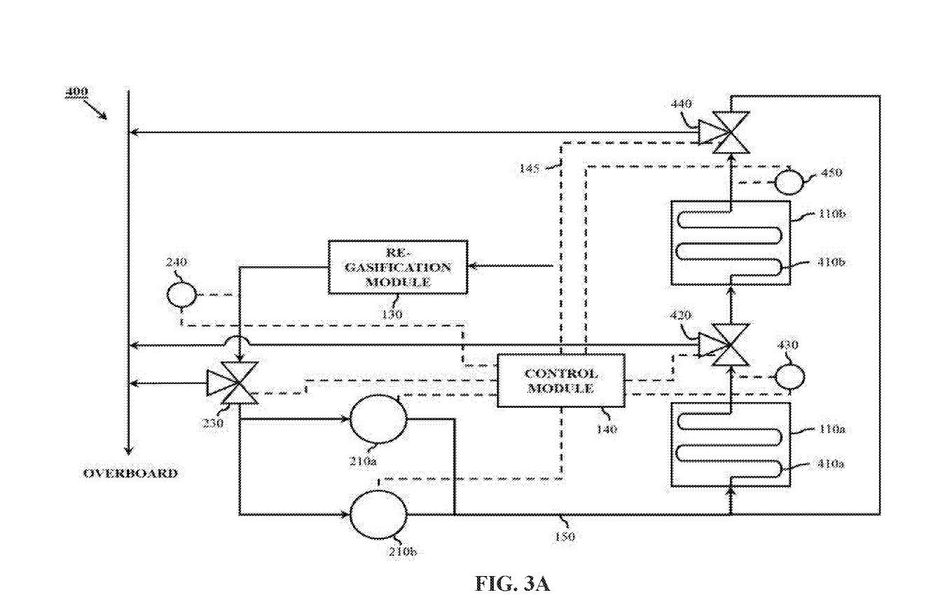

Additionally, the FSRU (100) comprises a regasification module (130) having an influent side (1301) and an effluent side (1302) and a control module (140) as shown in FIG. 1A and FIG. 1B. The regasification module (130) is configured to convert Liquefied Natural Gas (LNG) stored on hoard FSRU (100) into natural gas using heat from influent sea water coming in from the influent side (1301), giving out effluent sea water from the effluent side (1302). The effluent sea water needs to be reheated to an acceptable temperature before being discharged back into the sea. Returning to FIG. 1A, the control module (140) is configured to control the functioning of a number of systems on-board the FSRU (100) including the open loop vaporization system described herein, through a controller network (145) (not shown in FIG. 1A, but shown in FIGS. 2A, 3A and 4A of the following discussion).

FIG. 2A illustrates an open loop vaporization system (200), in accordance with an embodiment of the present invention. As shown in the FIG. 2A, the system (200) comprises a plurality of auxiliary pumps (210) (for e.g. 210a and 210b) configured to draw sea water from the plurality of sea chests (122). In various embodiments independent sea chests dedicated for the plurality of auxiliary pumps (210) are provided in addition to the plurality of sea chests (122) typical for the FSRU (100). Further, the system (200) comprises a throttling valve (220), the throttling valve (220) being temperature controlled. As shown in FIG. 2B, the throttling valve (220) has a valve inlet (2201) and a valve outlet (2202), the valve inlet (2201) being connected in line with the plurality of auxiliary pumps (210). Further, the throttling valve (220) is configured to be controlled by the control module (140) through the controller network (145). The plurality of auxiliary pumps (210) too are configured to be actuated by the control module (140) through the controller network (145).

Further the system (200) comprises a first junction (250). As shown in FIG. 2C, the first junction (250) has a primary first junction inlet (2501), a secondary first junction inlet (2502) and a first junction outlet (2503). The valve outlet (2202) of the throttling valve (220) is connected with the primary first junction inlet (2501). Further the system (200) comprises a second junction (260). As shown in FIG. 2D, the second junction (260) has a primary second junction inlet (2601), a secondary second junction inlet (2602) and a second junction outlet (2603). The first junction outlet (2503) is connected with the primary second junction inlet (2601). The secondary second junction inlet (2602) is connected with the effluent side (1302).

Further, the system (200) comprises a first three-way valve (230). The first three-way valve (230) is temperature controlled. As shown in FIG. 2E the first three-way valve (230) has a first three-way valve inlet (2301), a primary first three-way valve outlet (2302) and a secondary first three-way valve outlet (2303). The first three-way valve inlet (2301) is connected with the second junction outlet (2603). Further, a first temperature sensor (240) is connected to the piping (150) at the effluent side (1302). Also, an auxiliary temperature sensor (245) is connected to the piping (150) at the first three-way valve inlet (2301). The primary first three-way valve outlet (2302) is connected to an overboard line of the piping (150). The secondary first three-way valve outlet (2303) is connected to the secondary first junction inlet (2502). Hence a loop is formed within the first three-way valve (230), the first junction (250) and the second junction (260). Further, the first three-way valve (230) is configured to be controlled by the control module (140) through the controller network (145).

In use, the effluent sea-water leaving the regasification module (130) reaches the first three-way valve inlet (2301) through the second junction (260). The first temperature sensor (240) measures a first temperature value in the piping (150) at the effluent side (1302) of the regasification module (130) and transmits the first temperature value to the control module (140). If the first temperature value is higher than a reference temperature value preset in the control module (140) as per local maritime regulations, the primary first three-way valve outlet (2302) is opened by the control module (140) and the effluent sea water is allowed to be discharged overboard through the overboard line. If, however, the first temperature value is lower than the reference temperature value, the primary first three-way valve outlet (2302) is kept closed and at least one of the plurality of auxiliary pumps (210) are actuated from by the control module (140), drawing in influent sea-water from the plurality of sea-chests (122). The operating point (head and flow) along a pump curve of the plurality of auxiliary pumps (210) depends on the first temperature value. The throttling valve (220) is actuated by the control module (140) to regulate flow of the influent sea water in the piping (150). The throttling valve (220) is proportionally controlled by the control module (140) to ensure that just the right amount of influent sea water required is made to mix with the effluent sea water.

The effluent sea water is exited out of the secondary first three-way valve outlet (2303) and made to mix with the influent sea water at the first junction (250), creating an effluent-influent mix. The effluent-influent mix leaves the first junction (250) at the first junction outlet (2503) and enters the second junction (260) through the primary second junction inlet (2601). Additional effluent sea water entering through the secondary second junction inlet (2602) may be mixed with the effluent-influent mix at the second junction (260).

The effluent-influent mix leaves the second junction (260) through the second junction outlet (2603) and reaches the first three-way valve inlet (2301). The auxiliary temperature sensor (245) measures an auxiliary temperature value in the piping (150) at the first three-way valve inlet (2301) and transmits the auxiliary temperature value to the control module (140). If the auxiliary temperature value is higher than the reference temperature value, the control module (140) opens the primary first three-way valve outlet (2302) and allows the effluent-influent mix to be discharged overboard. If, however, the auxiliary temperature value is lower than the reference temperature value, the primary first three-way valve outlet (2302) is kept closed by the control module (140) and the effluent-influent mix is re-circulated inside the loop, through the secondary first three-way valve outlet (2303), receiving additional influent sea water from the throttling valve (220) at the first junction (250), until the auxiliary temperature value exceeds the reference temperature value.

Once the auxiliary temperature value exceeds the reference temperature value, the primary first three-way valve outlet (2302) is opened by the control module (140) and the influent-effluent mix is allowed to be discharged overboard. However, the proportional control of the throttling valve (220) ensures optimal performance of the system (200) by minimizing or eliminating recirculation of the effluent-influent mix inside the loop. This system allows for instantaneous mixing of the influent and effluent sea water inside the piping (150) for a homogenous mixture of the cooler and warmer sea waters delivering a single stream with consistent and the acceptable discharge temperature.

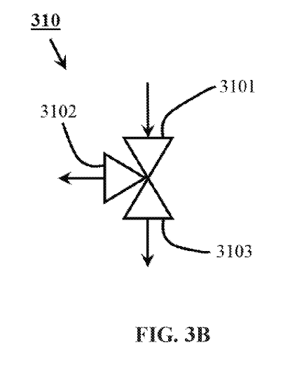

FIG. 3A illustrates an open loop vaporization system (300), in accordance with another embodiment of the present invention. As shown in FIG. 3A, in the system (300), the effluent side (1302) is connected with the first three-way valve inlet (2301) of the first three-way valve (230). Further, the first temperature sensor (240) is connected to the piping (150) at the first three-way valve inlet (2301). The primary first three-way valve outlet (2302) is connected to the overboard line of the piping (150). Also, the secondary first three-way valve outlet (2303) is connected with a plurality of auxiliary tank inlets (1103) (for e.g. 1103a, 1103b, 1103c . . . 1103x, 1103y) (not shown in FIG. 3A) of the plurality of respective ballast tanks (110).

Further, the system (300) comprises the plurality of auxiliary pumps (210) connected to a plurality of auxiliary tank outlets (1104) (for e.g. 1104a, 1104b, 1104c . . . 1104x, 1104y) (not shown in FIG. 3A) of the plurality of respective ballast tanks (110). A second three-way valve (310) is connected in line with the plurality of auxiliary pumps (210). The second three-way valve (310) is also temperature controlled. The second three-way valve (310) is configured to be actuated by the control module (140). As shown in FIG. 3B, the second three-way valve (310) comprises a second three-way valve inlet (3101), a primary second three-way valve outlet (3102) and a secondary second three-way valve outlet (3103). The second three-way valve inlet (3101) is connected to the plurality of auxiliary pumps (210). Further, a second temperature sensor (320) is connected to the piping (150) at the second three-way valve inlet (3101). Further, the primary second three-way valve outlet (3102) is connected with the overboard line of the piping (150). Also, the secondary second three-way valve outlet (3103) is connected with the plurality of auxiliary tank inlets (1103).

In use, the effluent sea water leaves the effluent side (1302) and reaches the first three-way valve inlet (2301). The first temperature sensor (240) measures the first temperature value and transmits the first temperature value to the control module (140). If the first temperature value is higher than the reference temperature value, the primary first three-way valve outlet (2302) is kept open by the control module (140) and the effluent sea water is allowed to be discharged overboard through the overboard line. If, however, the first temperature value is lower than the reference temperature value, the primary first three-way valve outlet (2302) is kept closed by the control module (140). The effluent sea water then exits through the secondary first three-way valve outlet (2303) and enters the plurality of ballast tanks (110) through the plurality of auxiliary tank inlets (1103). The plurality of ballast tanks (110) act as holding tanks. In accordance with an embodiment of the invention, the plurality of ballast tanks (110) are of double bottom ballast type. There is a minimum level of 1-1.5 m of ballast sea water in the double bottom ballast water tanks for all weather and met ocean conditions. The effluent sea water is dumped into the plurality of ballast tanks (110) which results in effluent-ballast sea water mixture. Additional influent sea water can be pumped or gravity fed into the plurality of ballast tanks to raise the overall temperature of the effluent-ballast sea water mixture until the temperature of the effluent-ballast sea water mixture is above the reference temperature value.

The effluent-ballast sea water mixture is then pumped by the plurality of auxiliary pumps (210) through the plurality of auxiliary tank outlets (1104). In accordance with an embodiment, the plurality of auxiliary tank outlets (1104) are positioned opposite to the plurality of ballast water inlets (1101) and the plurality of ballast water outlets (1102) for better mixing. The effluent-ballast sea water mixture then reaches the second three-way valve inlet (3101). The second temperature sensor (320) measures a second temperature value in the piping (150) and transmits the second temperature value to the control module (140). If the second temperature value is higher than the reference temperature value, the primary second three-way valve outlet (3102) is opened In the control module (140) and the effluent-ballast sea water mixture is discharged overboard.

If, however, the second temperature value is lower than the reference temperature value, the primary second three-way valve outlet (3102) is kept closed and the effluent-ballast sea water mixture exits through the secondary second three-way valve outlet (3103) and enters the plurality of ballast tanks (110) through the plurality of auxiliary tank inlets (1103). This cycle is repeated until the temperature of the effluent-ballast sea water mixture goes higher than the reference temperature value.

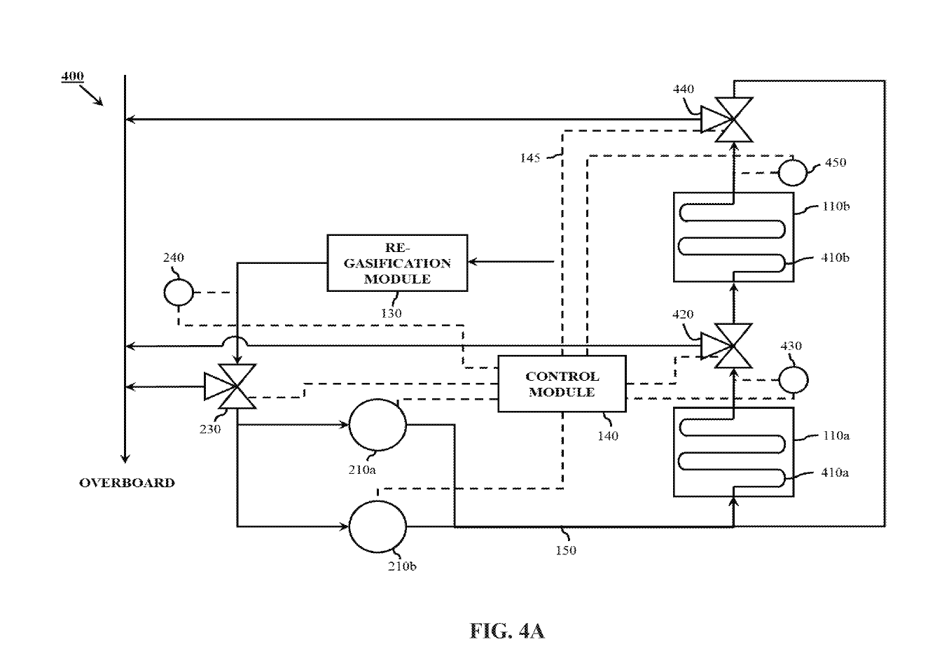

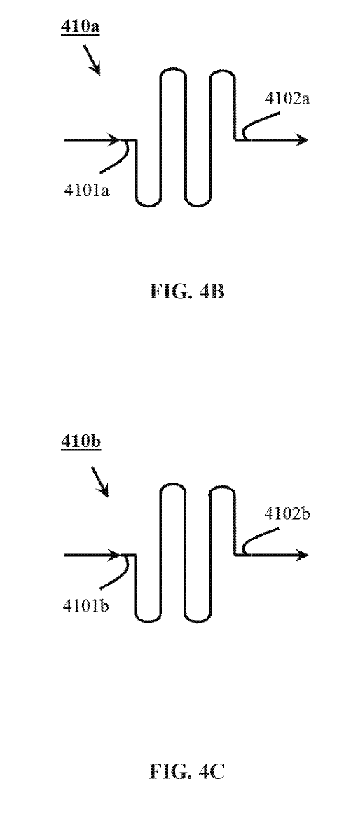

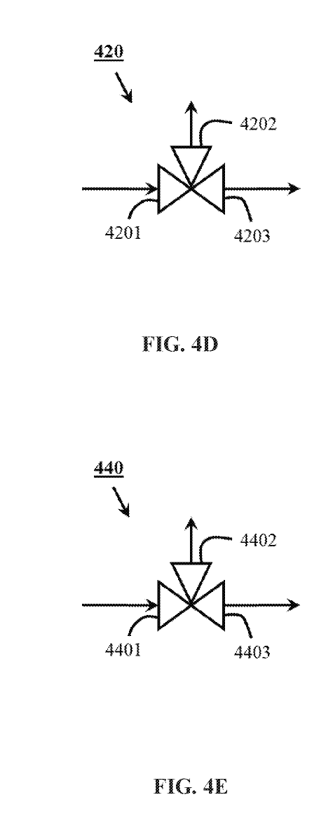

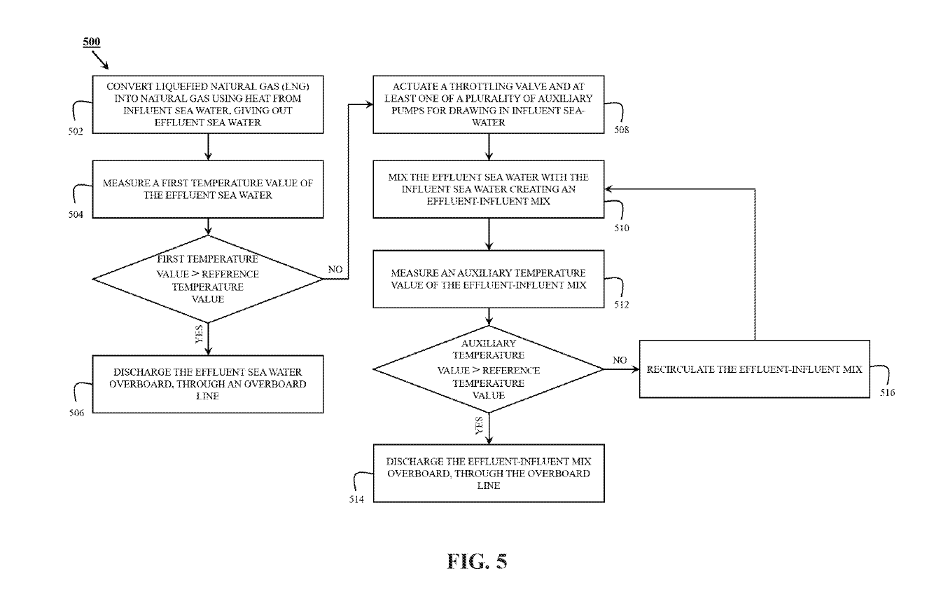

FIG. 4A illustrates an open loop vaporization system (400), in accordance with an embodiment of the present invention. As shown in FIG. 4A, in the system (400), a first heat exchanger (410a) is provided inside a first ballast tank (110a) of the plurality of ballast tanks (110) and a second heat exchanger (410b) is provided inside a second ballast tank (110b) of the plurality of ballast tanks (110). The first heat exchanger (410a) as shown in FIG. 4B has a first heat exchanger inlet (4101a) and a first heat exchanger outlet (4102a). The second heat exchanger (410b) as shown in FIG. 4C has a second heat exchanger inlet (4101b) and a second heat exchanger outlet (4102b). Preferably, the first heat exchanger (410a) and the second heat exchanger (410b) are made up high-thermal conductivity material. Further, corrosion and pitting resistance have also been accounted for.

Further, a third three-way valve (420) as shown in FIG. 4D is provided between the first heat exchanger outlet (4102a) and the second heat exchanger inlet (4101b). Further, the third three-way valve (420) is also temperature controlled. The third three-way valve (420) has a third three-way valve inlet (4201), a primary third three-way valve outlet (4202) and a secondary third three-way valve outlet (4203). Further, a fourth three-way valve (440) as shown in FIG. 4E is provided between the second heat exchanger outlet (4102b) and the first heat exchanger inlet (4101a), the fourth three-way valve (440) also being temperature controlled. The fourth three-way valve (440) has a fourth three-way valve inlet (4401), a primary fourth three-way valve outlet (4402) and a secondary fourth three-way valve outlet (4403).

Returning to FIG. 4A, the effluent side (1302) is connected with the first three-way valve inlet (2301) of the first three-way valve (230). Further, the first temperature sensor (240) is connected to the piping (150) at the first three-way valve inlet (2301). The primary first three-way valve outlet (2302) is connected to the overboard line of the piping (150). Also, the secondary first three-way valve outlet (2303) is connected with the plurality of auxiliary pumps (210). The plurality of auxiliary pumps (210) is in turn connected with the first heat exchanger inlet (4101a). The first heat exchanger outlet (4102a) is connected to the third three-way valve inlet (4201). Further, a third temperature sensor (430) is connected to the piping (150) at the third three-way valve inlet (4201). The primary third three-way valve outlet (4202) is connected with overboard line of the piping (150).

The secondary third three-way valve outlet (4203) is connected to the second heat exchanger inlet (4101b). The second heat exchanger outlet (4102b) is in turn connected with the fourth three-way valve inlet (4401). Further, a fourth temperature sensor (450) is connected to the piping (150) at the fourth three-way valve inlet (4401). The primary fourth three-way valve outlet (4402) is connected with the overboard line. The secondary fourth three-way valve outlet (4403) is in turn connected with the first heat exchanger inlet (4101a). It is to be noted here that only two heat exchangers in two ballast tanks, viz., the first ballast tank (110a) and the second ballast tank (110b) having the respective first heat exchanger (410a) and the second heat exchanger (410b) with the third three-way valve (420) and the fourth three-way valve (440) have been presented here for sake of clarity of discussion. The set up can be extended to any number of ballast tanks provided with one or more heat exchangers each and three-way valves in between the ballast tanks, as per the demands of the system.

In use, when the effluent sea water leaves the effluent side (1302) of the regasification module (130), the effluent sea water reaches the first three-way valve inlet (2301). The first temperature sensor (240) measures the first temperature value in the piping (150) and transmits the first temperature value to the control module (140). If the first temperature value is higher than the reference temperature value, the control module (140) opens the primary first three-way valve outlet (2302) and the effluent sea water is discharged overboard through the overboard line. However, if in case the first temperature value is lower than the reference temperature value, the primary first three-way valve outlet (2302) is kept closed and the secondary first three-way valve outlet (2303) is opened by the control module (140). The effluent sea water is pumped by the plurality of auxiliary pumps (210) into the first heat exchanger (410a) through the first heat exchanger inlet (4101a). In accordance with an embodiment, the first heat exchanger (410a) and the second heat exchanger (410b) are submerged in at least 1 to 1.5 m of ballast sea water. The effluent sea water absorbs heat from the ballast sea water in the process. Additional influent sea water can be pumped or gravity fed into the plurality of ballast tanks (110).

The effluent sea water exits the first heat exchanger (410a) and reaches the third three-way valve inlet (4201). The third temperature sensor (430) measures a third temperature value of the effluent sea water and transmits the third temperature value to the control module (140). If the third temperature value is higher than the reference temperature value, then the control module (140) opens the primary third three-way valve outlet (4202) and the effluent sea water is discharged overboard. If, however, the third temperature value is lower than the reference temperature value, the control module (140) opens the secondary third three-way valve outlet (4203) and the effluent sea water enters the second heat exchanger (410b) at the second heat exchanger inlet (4101b). Here again, the effluent sea water absorbs heat from the ballast sea water in the process.

The effluent sea water exits the second heat exchanger (410b) and reaches the fourth three-way valve inlet (4401). The fourth temperature sensor (450) measures a fourth temperature value of the effluent sea water and transmits the fourth temperature value to the control module (140). If the fourth temperature value is higher than the reference temperature value, then the control module (140) opens the primary fourth three-way valve outlet (4402) and the effluent sea water is discharged overboard. If, however, the fourth temperature value is lower than the reference temperature value, the control module (140) opens the secondary fourth three-way valve outlet (4403) and the effluent sea water enters the first heat exchanger (410a) at the first heat exchanger inlet (4101a). The cycle is repeated until the temperature of the effluent sea water goes above the reference temperature value.

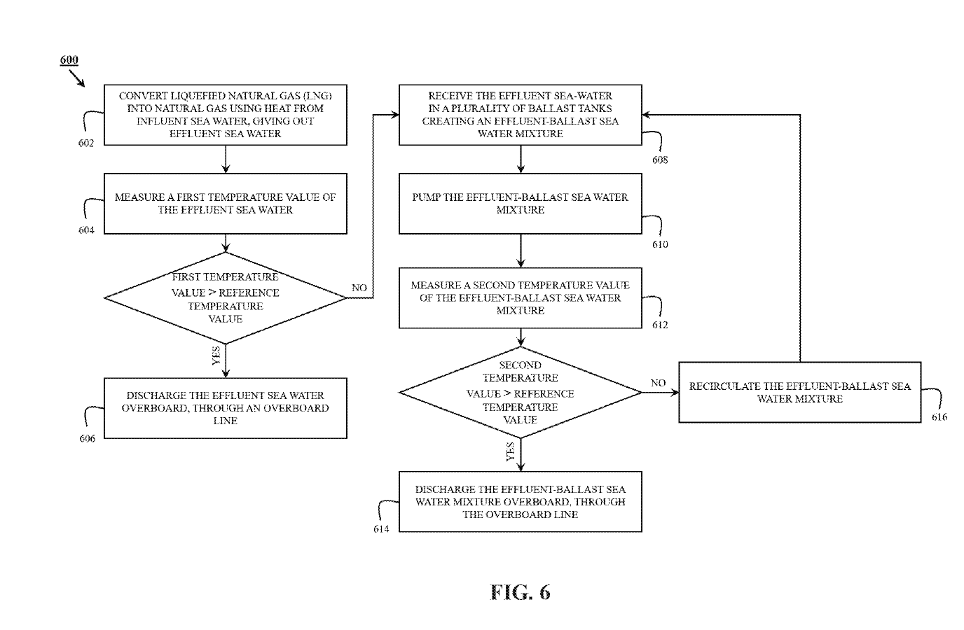

FIG. 5 illustrates the method (500) of open loop vaporization, in accordance with an embodiment of the invention. The method (500) begins at step 502, by converting Liquefied Natural Gas (LNG) stored on board the FSRU (100) into natural gas using heat from influent sea water coming in from influent side (1301), giving out effluent sea water from an effluent side (1302), by the regasification module (130). At step 504, the first temperature value of the effluent sea water is measured, in piping (150), at the effluent side (1302) of the regasification module (130). At step 506, a primary first three-way valve outlet (2302) of the first three-way valve (230) is opened and the effluent sea water is discharged overboard, through an overboard line, if the first temperature value is higher than the reference temperature value. At step 508, the primary first three-way valve outlet (2302) is closed and the throttling valve (220) and at least one of the plurality of auxiliary pumps (210) are actuated, for drawing in the influent sea-water from the plurality of sea-chests (122), if the received first temperature value is lower than the reference temperature value. At step 510, the effluent sea water is allowed to exit out of the first three-way valve (230) and mix with the influent sea water at a first junction (250), creating an effluent-influent mix. At step 512, the auxiliary temperature value of the effluent-influent mix is measured, in the piping (150) at the first three-way valve inlet (2301). At step 514, the primary first three-way valve outlet (2302) is opened and the effluent-influent mix is discharged overboard through the overboard line, if the auxiliary temperature value is higher than the reference temperature value.

In accordance with an embodiment of the invention, at step 516, the primary first three-way valve outlet (2302) is closed, if the auxiliary temperature value is lower than the reference temperature value and the effluent-influent mix is allowed to re-circulate through the secondary first three-way valve outlet (2303), receiving the additional influent sea water from the throttling valve (220) at the first junction (250), until the auxiliary temperature value exceeds the reference temperature value.

FIG. 6 illustrates a method (600) of open loop vaporization, in accordance with an embodiment of the invention. The method (600) begins at step 602, by converting Liquefied Natural Gas (LNG) stored on board the FSRU (100) into natural gas using heat from influent sea water coming in from influent side (1301), giving out effluent sea water from effluent side (1302), by the regasification module (130). At step 604, the effluent sea water leaving through the effluent side (1302), is received at the first three-way valve inlet (2301) of the first three-way valve (230) and the first temperature value of the effluent sea water is measured, in piping (150), at the first three-way valve inlet (2301). At step 606, the primary first three-way valve outlet (2302) of the first three-way valve (230) is opened and the effluent sea water is discharged overboard through the overboard line, if the first temperature value is higher than the reference temperature value. At step 608, the primary first three-way valve outlet (2302) is closed, if the first temperature value is lower than the reference temperature value and the effluent sea-water exiting the secondary first three-way valve outlet (2303) of the first three-way valve (230) is received, in the plurality of ballast tanks (110) through the plurality of auxiliary tank inlets (1103), creating the effluent-ballast sea water mixture. At step 610, the effluent-ballast sea water mixture is pumped through the plurality of auxiliary tank outlets (1104) and the effluent-ballast sea water mixture received at the second three-way valve inlet (3101) of the second three-way valve (310). At step 612, the second temperature value of the effluent-ballast sea water mixture is measured, in the piping (150) at the second three-way valve inlet (3101). At step 614, the primary second three-way valve outlet (3102) of the second three-way valve (310) is opened and the effluent-ballast sea water mixture is discharged overboard, if the second temperature value is higher than the reference temperature value.

In accordance with an embodiment of the present invention, at step 616, the primary second three-way valve outlet (3102) is closed and the effluent-ballast sea water mixture is allowed to exit through the secondary second three-way valve outlet (3103) of the second three-way valve (310) and enter the plurality of ballast tanks (110) through the plurality of auxiliary tank inlets (1103), if the second temperature value is lower than the reference temperature value.

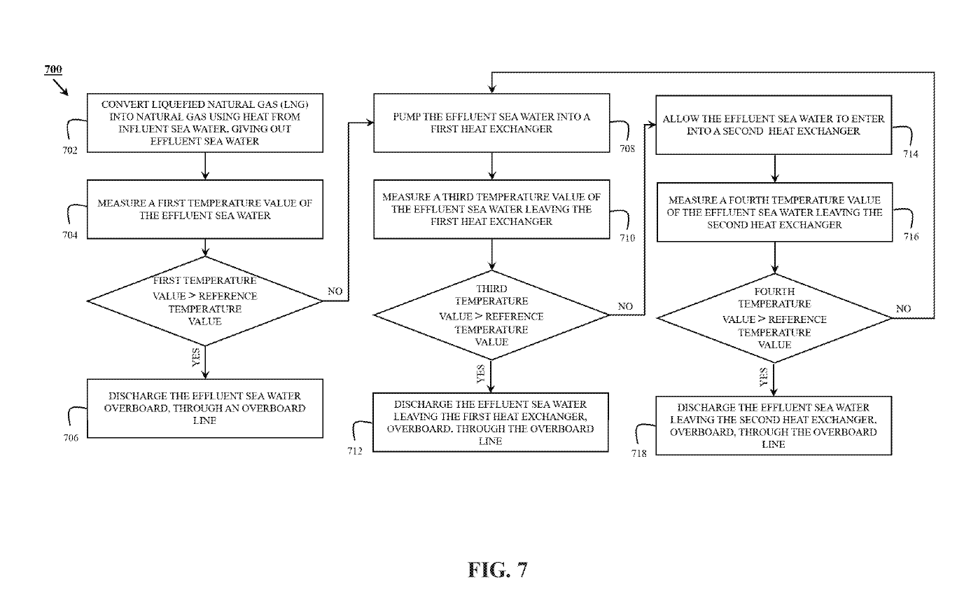

FIG. 7 illustrates the method (700) of open loop vaporization, in accordance with an embodiment of the invention. The method (700) beings at step 702, by converting Liquefied Natural Gas (LNG) stored on board the FSRU (100) into natural gas using heat from the influent sea water coming in from the influent side (1301), giving out the effluent sea water from the effluent side (1302), by the regasification module (130). At step 704, the effluent sea water leaving through the effluent side (1302) is received at the first three-way valve inlet (2301) of the first three-way valve (230) and the first temperature value of the effluent sea water is measured, in the piping (150), at the first three-way valve inlet (2301). At step 706, a primary first three-way valve outlet (2302) of the first three-way valve (230) is opened and the effluent sea water is discharged overboard through the overboard line, if the first temperature value is higher than the reference temperature value. At step 708, the effluent sea water is pumped into the first heat exchanger (410a) through the first heat exchanger inlet (4101a) and the effluent sea water leaving the first heat exchanger (410a) is received at the third three-way valve inlet (4201) of the third three-way valve (420). At step 710, a third temperature value of the effluent sea water leaving the first heat exchanger (410a) is measured at the third three-way valve inlet (4201). At step 712, the primary third three-way valve outlet (4202) of the third three-way valve (420) is opened and the effluent sea water leaving the first heat exchanger is discharged, overboard, if the third temperature value is higher than the reference temperature value.

In accordance with an embodiment of the present invention, at step 714, the secondary third three-way valve outlet (4203) is opened and the effluent sea water is allowed to enter into the second heat exchanger (410) at the second heat exchanger inlet (4101b), if the third temperature value is lower than the reference temperature value. At step 716, the fourth temperature value of the effluent sea water leaving the second heat exchanger (410b), is measured at the fourth three-way valve inlet (4401). At step 718, the primary fourth three-way valve outlet (4402) of the fourth three-way valve (440) is opened and the effluent sea water leaving the second heat exchanger is discharged overboard, if the fourth temperature value is higher than the reference temperature value.

It is to be noted that in all of the embodiments discussed above, the plurality of ballast pumps (124) may be used to support or replace the plurality of auxiliary pumps (210) during failure of the plurality of auxiliary pumps (210) or by design. Further, the embodiments have been described with minimum number of components required to enable the open loop vaporization system. Additional components such as additional valves, check valves, filters, sensors (including temperature differential sensors), controllers, field devices etc. may be employed in various locations of the piping (150) to enhance the overall reliability of the open loop vaporization system and method.

The open loop vaporization system offers the number of advantages. The system involves implementation of standard equipment such as pumps, valves and piping and does not require any complex piece of equipment. Further, the system is cost effective and efficient. Moreover, the system ensures the discharged sea water system is within the national and international guidelines to protect the marine environment. Therefore, the system discharges seawater at the temperature within the acceptable limits.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art front the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

1. An open loop vaporization system (200), comprising:
a regasification module (130) having an influent side (1301) and an effluent side (1302);
a plurality of auxiliary pumps (210) configured to draw sea water from a plurality of sea chests (122);
a first junction (250), the first junction (250) having a primary first junction inlet (2501), a secondary first junction inlet (2502) and a first junction outlet (2503);
a second junction (260), the second junction (260) having a primary second junction inlet (2601), a secondary second junction inlet (2602) and a second junction outlet (2603), the first junction outlet (2503) being connected with the primary second junction inlet (2601) and the secondary second junction inlet (2602) being connected with the effluent side (1302);
a first three-way valve (230), the first three-way valve (230) having a first three-way valve inlet (2301), a primary first three-way valve outlet (2302) and a secondary first three-way valve outlet (2303);
a throttling valve (220) having a valve inlet (2201) and a valve outlet (2202), the valve inlet (2201) being connected in line with a plurality of auxiliary pumps (210) and the valve outlet (2202) being connected with the primary first junction inlet (2501);
a control module (140) with a controller network (145);
a first temperature sensor (240) connected with piping (150) at the effluent side (1302);
wherein the throttling valve (220) and the plurality of auxiliary pumps (210) are configured to be actuated by the control module (140) through the controller network (145);
wherein the first three-way valve (230) and the throttling valve (220) are temperature controlled;
wherein the first junction (250), the second junction and the first three-way valve (230) form a loop;
wherein the regasification module (130) is configured to convert Liquefied Natural Gas (LNG) stored on board an FSRU (100) into natural gas using heat from influent sea water coming in from the influent side (1301), giving out effluent sea water from the effluent side (1302);
wherein the first three-way valve inlet (2301) is configured to receive the effluent sea water leaving the regasification module (130), through the second junction (260);
wherein the first temperature sensor (240) is configured to measure a first temperature value in the piping (150) at the effluent side (1302) of the regasification module (130) and transmit the first temperature value to the control module (140);
wherein the control module (140) is configured to open the primary first three-way valve outlet (2302) and discharge the effluent sea water overboard through an overboard line, if the received first temperature value is higher than a reference temperature value.

2. The system (200) as claimed in claim 1, wherein the control module (140) is further configured to close the primary first three-way valve outlet (2302) and actuate at least one of the plurality of auxiliary pumps (210), drawing in influent sea-water from the plurality of sea-chests (122), if the received first temperature value is lower than the reference temperature value;
wherein the secondary first three-way valve outlet (2303) is configured to allow the effluent sea water to exit out of the first three-way valve (230) and mix with the influent sea water at the first junction (250), creating an effluent-influent mix;
wherein the first junction outlet (2503) is configured to allow the effluent-influent mix to leave the first junction (250) and enter the second junction (260) through the primary second junction inlet (2601).

3. The system (200) as claimed in claim 2, wherein the second junction (260) is configured to mix additional effluent sea water entering through the secondary second junction inlet (2602) with the effluent-influent mix.

4. The system (200) as claimed in claim 2, wherein the second junction outlet (2603) is configured to allow the effluent-influent mix to leave the second junction (260) and reach the first three-way valve inlet (2301).

5. The system (200) as claimed in claim 4, further comprising an auxiliary temperature sensor (245) connected with the piping (150) at the first three-way valve inlet (2301);
wherein the auxiliary temperature sensor (245) is configured to measure an auxiliary temperature value in the piping (150) at the first three-way valve inlet (2301) and transmit the auxiliary temperature value to the control module (140).
wherein the control module (140) is further configured to open the primary first three-way valve outlet (2302) and discharge the effluent-influent mix overboard, if the auxiliary temperature value is higher than the reference temperature value.

6. The system (200) as claimed in claim 5, wherein the control module (140) is further configured to close the primary first three-way valve outlet (2302), if the auxiliary temperature value is lower than the reference temperature value.

7. The system (200) as claimed in claim 5, wherein the loop is configured to allow the effluent-influent mix to re-circulate through the secondary first three-way valve outlet (2303), receiving additional influent sea water from the throttling valve (220) at the first junction (250), until the auxiliary temperature value exceeds the reference temperature value.

8. An open loop vaporization system (300), comprising:
a plurality of ballast tanks (110);
a plurality of auxiliary pumps (210) connected with a plurality of auxiliary tank outlets (1104) of the plurality of respective ballast tanks (110);
a regasification module (130) having an influent side (1301) and an effluent side (1302);
a first three-way valve (230), the first three-way valve (230) having a first three-way valve inlet (2301), a primary first three-way valve outlet (2302) and a secondary first three-way valve outlet (2303), the effluent side (1302) being connected with the first three-way valve inlet (2301) of the first three-way valve (230);
a second three-way valve (310), the second three-way valve (310) having a second three-way valve inlet (3101), a primary second three-way valve outlet (3102) and a secondary second three-way valve outlet (3103), the second three-way valve inlet (3101) being connected with the plurality of auxiliary pumps (210), the primary second three-way valve outlet (3102) being connected with an overboard line of piping (150) and the secondary second three-way valve outlet (3103) being connected with a plurality of auxiliary tank inlets (1103) of the plurality of respective ballast tanks (110);
a control module (140) with a controller network (145);
a first temperature sensor (240) connected with the piping (150) at the first three-way valve inlet (2301);
a second temperature sensor (320) connected with the piping (150) at the second three-way valve inlet (3101);
wherein the regasification module (130) is configured to convert Liquefied Natural Gas (LNG) stored on board an FSRU (100) into natural gas using heat from influent sea water coming in from the influent side (1301), giving out effluent sea water from the effluent side (1302);
wherein the first three-way valve (230) and second three-way valve (310) are temperature controlled and are configured to be actuated by the control module (140) through the controller network (145);
wherein the first three-way valve inlet (2301) is configured to receive the effluent sea water leaving through the effluent side (1302);
wherein the first temperature sensor (240) is configured to measure a first temperature value and transmit the first temperature value to the control module (140); and
wherein the control module (140) is configured to open the primary first three-way valve outlet (2302) and discharge the effluent sea water overboard through the overboard line, if the first temperature value is higher than the reference temperature value.

9. The system (300) as claimed in claim 8, wherein the control module (140) is further configured to close the primary first three-way valve outlet (2302), if the first temperature value is lower than the reference temperature value;
wherein the plurality of ballast tanks (110) is configured to receive the effluent sea water through the plurality of auxiliary tank inlets (1103), exiting the secondary first three-way valve outlet (2303);
wherein the plurality of auxiliary pumps (210) is configured to pump the effluent-ballast sea water mixture, through the plurality of auxiliary tank outlets (1104);
wherein the second three-way valve inlet (3101) is configured to receive the effluent-ballast sea water mixture;
wherein, the second temperature sensor (320) is configured to measure a second temperature value in the piping (150) and transmit the second temperature value to the control module (140); and
wherein the control module (140) is configured to open the primary second three-way valve outlet (3102) and discharge the effluent-ballast sea water mixture overboard, if the second temperature value is higher than the reference temperature value.

10. The system (300) as claimed in claim 9, wherein the control module (140) is configured to close the primary second three-way valve outlet (3102) and allow the effluent-ballast sea water mixture to exit through the secondary second three-way valve outlet (3103) and enter the plurality of ballast tanks (110) through the plurality of auxiliary tank inlets (1103), if the second temperature value is lower than the reference temperature value.

11. An open loop vaporization system (400), comprising:
a first heat exchanger (410a) provided inside a first ballast tank (110a) of a plurality of ballast tanks (110), the first heat exchanger (410a) having a first heat exchanger inlet (4101a) and a first heat exchanger outlet (4102a);
a plurality of auxiliary pumps (210) connected with the first heat exchanger inlet (4101a);
a regasification module (130) having an influent side (1301) and an effluent side (1302);
a first three-way valve (230), the first three-way valve (230) having a first three-way valve inlet (2301), a primary first three-way valve outlet (2302) and a secondary first three-way valve outlet (2303), the effluent side (1302) being connected with the first three-way valve inlet (2301) of the first three-way valve (230), the primary first three-way valve outlet (2302) being connected with an overboard line of piping (150), the secondary first three-way valve outlet (2303) being connected with the plurality of auxiliary pumps (210);
a third three-way valve (420), the third three-way valve (420) having a third three-way valve inlet (4201), a primary third three-way valve outlet (4202) and a secondary third three-way valve outlet (4203), the third three-way valve inlet (4201) being connected with the first heat exchanger outlet (4102a) and the primary third three-way valve outlet (4202) being connected with the overboard line of the piping (150);
a first temperature sensor (240) connected with the piping (150) at the first three-way valve inlet (2301);
a third temperature sensor (430) connected with the piping (150) at the third three-way valve inlet (4201);
a control module (140) with a controller network (145);
wherein the regasification module (130) is configured to convert Liquefied Natural Gas (LNG) stored on board FSRU (100) into natural gas using heat from influent sea water coming in from the influent side (1301), giving out effluent sea water from the effluent side (1302);
wherein the first three-way valve inlet (2301) is configured to receive the effluent sea water leaving from the effluent side (1302) of the regasification module (130);
wherein the first temperature sensor (240) is configured to measure a first temperature value in the piping (150) and transmit the first temperature value to the control module (140); and
wherein the control module (140) is configured to open the primary first three-way valve outlet (2302) and discharge the effluent sea water overboard through the overboard line, if the first temperature value is higher than a reference temperature value.

12. The system (400) as claimed in claim 11, wherein the control module (140) is configured to close the primary first three-way valve outlet (2302) and open the secondary first three-way valve outlet (2303), if the first temperature value is lower than the reference temperature value;
wherein the plurality of auxiliary pumps (210) is configured to pump the effluent sea water into the first heat exchanger (410a) through the first heat exchanger inlet (4101a);
wherein the third three-way valve inlet (4201) is configured to receive the effluent sea water leaving the first heat exchanger (410a);
wherein the third temperature sensor (430) is configured to measure a third temperature value of the effluent sea water and transmit the third temperature value to the control module (140);
wherein the control module (140) is configured to open the primary third three-way valve outlet (4202) and discharge the effluent sea water leaving the first heat exchanger (410a), overboard, if the third temperature value is higher than the reference temperature value.

13. The system (400) as claimed in claim 12, further comprising
a second heat exchanger (410b) provided inside a second ballast tank (110b) of the plurality of ballast tanks (110), the second heat exchanger (410b) having a second heat exchanger inlet (4101b) connected with the secondary third three-way valve outlet (4203) and a second heat exchanger outlet (4102b);
wherein the control module (140) is configured to open the secondary third three-way valve outlet (4203) and allow the effluent sea water to enter into the second heat exchanger (410b) at the second heat exchanger inlet (4101b), if the third temperature value is lower than the reference temperature value.

14. The system (400) as claimed in claim 13, further comprising:
a fourth three-way valve (440), the fourth three-way valve (440) having a fourth three-way valve inlet (4401), a primary fourth three-way valve outlet (4402) and a secondary fourth three-way valve outlet (4403), the fourth three-way valve inlet (4401) being connected with the second heat exchanger outlet (4102b) and the primary fourth three-way valve outlet (4402) being connected with the overboard line of the piping (150);
a fourth temperature sensor (450) connected with the piping (150) at the fourth three-way valve inlet (4401);
wherein the fourth three-way valve inlet (4401) is configured to receive the effluent sea water leaving the second heat exchanger (410b);
wherein the fourth temperature sensor (450) is configured to measure a fourth temperature value of the effluent sea water and transmit the fourth temperature value to the control module (140);
wherein the control module (140) is configured to open the primary fourth three-way valve outlet (4402) and discharge the effluent sea water leaving the second heat exchanger (410b), overboard, if the fourth temperature value is higher than the reference temperature value.

15. A method (500) of open loop vaporization, comprising steps of:
converting (502) Liquefied Natural Gas (LNG) stored on board an FSRU (100) into natural gas using heat from influent sea water coming in from influent side (1301), giving out effluent sea water from an effluent side (1302), by a regasification module (130);
measuring (504) a first temperature value of the effluent sea water, in piping (150), at the effluent side (1302) of the regasification module (130);
opening (506) a primary first three-way valve outlet (2302) of a first three-way valve (230) and discharging the effluent sea water overboard through an overboard line, if the first temperature value is higher than a reference temperature value;
closing (508) the primary first three-way valve outlet (2302) and actuating a throttling valve (220) and at least one of a plurality of auxiliary pumps (210) for drawing in influent sea-water from a plurality of sea-chests (122), if the received first temperature value is lower than the reference temperature value;
allowing (510) the effluent sea water to exit out of the first three-way valve (230) and mix with the influent sea water at a first junction (250), creating an effluent-influent mix;
measuring (512) an auxiliary temperature value of the effluent-influent mix, in the piping (150) at the first three-way valve inlet (2301); and
opening (514) the primary first three-way valve outlet (2302) and discharging the effluent-influent mix overboard through the overboard line, if the auxiliary temperature value is higher than the reference temperature value.

16. The method (500) as claimed in claim 15, further comprising a step of closing (516) the primary first three-way valve outlet (2302), if the auxiliary temperature value is lower than the reference temperature value and allowing the effluent-influent mix to re-circulate through a secondary first three-way valve outlet (2303), receiving additional influent sea water from the throttling valve (220) at the first junction (250), until the auxiliary temperature value exceeds the reference temperature value.

17. A method (600) of open loop vaporization, comprising steps of:
converting (602) Liquefied Natural Gas (LNG) stored on board an FSRU (100) into natural gas using heat from influent sea water coming in from influent side (1301), giving out effluent sea water from effluent side (1302), by a regasification module (130);
receiving (604) the effluent sea water leaving through the effluent side (1302) at a first three-way valve inlet (2301) of a first three-way valve (230) and measuring a first temperature value of the effluent sea water, in piping (150), at the first three-way valve inlet (2301);
opening (606) a primary first three-way valve outlet (2302) of the first three-way valve (230) and discharging the effluent sea water overboard through an overboard line, if the first temperature value is higher than a reference temperature value;
closing (608) the primary first three-way valve outlet (2302), if the first temperature value is lower than the reference temperature value and receiving the effluent sea-water exiting a secondary first three-way valve outlet (2303) of a first three-way valve (230), in a plurality of ballast tanks (110) through a plurality of auxiliary tank inlets (1103), creating an effluent-ballast sea water mixture;
pumping (610) the effluent-ballast sea water mixture, through a plurality of auxiliary tank outlets (1104) and receiving the effluent-ballast sea water mixture in a second three-way valve inlet (3101) of a second three-way valve (310);
measuring (612) a second temperature value of the effluent-ballast sea water mixture, in the piping (150) at the second three-way valve inlet (3101); and
opening (614) a primary second three-way valve outlet (3102) of the second three-way valve (310) and discharging the effluent-ballast sea water mixture overboard, if the second temperature value is higher than the reference temperature value.

18. The method (600) as claimed in claim 17, further comprising a step of closing (616) the primary second three-way valve outlet (3102) and allowing the effluent-ballast sea water mixture to exit through the secondary second three-way valve outlet (3103) of the second three-way valve (310) and enter the plurality of ballast tanks (110) through the plurality of auxiliary tank inlets (1103), if the second temperature value is lower than the reference temperature value.

19. A method (700) of open loop vaporization, comprising steps of:
converting (702) Liquefied Natural Gas (LNG) stored on board FSRU (100) into natural gas using heat from influent sea water coming in from an influent side (1301), giving out effluent sea water from the effluent side (1302), by a regasification module (130);
receiving (704) the effluent sea water leaving through the effluent side (1302) at a first three-way valve inlet (2301) of a first three-way valve (230) and measuring a first temperature value of the effluent sea water, in piping (150), at the first three-way valve inlet (2301);
opening (706) a primary first three-way valve outlet (2302) of the first three-way valve (230) and discharging the effluent sea water overboard through an overboard line, if the first temperature value is higher than a reference temperature value;
pumping (708) the effluent sea water into a first heat exchanger (410a) through a first heat exchanger inlet (4101a) and receiving the effluent sea water leaving the first heat exchanger (410a) at a third three-way valve inlet (4201) of a third three-way valve (420);
measuring (710) a third temperature value of the effluent sea water leaving the first heat exchanger (410a), at the third three-way valve inlet (4201); and
opening (712) a primary third three-way valve outlet (4202) of the third three-way valve (420) and discharging the effluent sea water leaving the first heat exchanger (410a), overboard, if the third temperature value is higher than the reference temperature value.

20. The method (700) as claimed in claim 19, further comprising steps of:
opening (714) the secondary third three-way valve outlet (4203) and allowing the effluent sea water to enter into a second heat exchanger (410b) at a second heat exchanger inlet (4101b), if the third temperature value is lower than the reference temperature value;
measuring (716) a fourth temperature value of the effluent sea water leaving the second heat exchanger (410b), at the fourth three-way valve inlet (4401); and
opening (718) a primary fourth three-way valve outlet (4402) of the fourth three-way valve (440) and discharging the effluent sea water leaving the second heat exchanger (410b), overboard, if the fourth temperature value is higher than the reference temperature value.
